(19) United States
(12) Patent Application Publication
(10) Pub. No.: US 2025/0300282 A1
(43) Pub. Date: Sep. 25, 2025

(54) SECONDARY BATTERY

(71) Applicant: Samsung SDI Co., Ltd., Yongin-si (KR)

(72) Inventor: Jun Ho BYEON, Yongin-si (KR)

(21) Appl. No.: 18/911,026

(22) Filed: Oct. 9, 2024

(30) Foreign Application Priority Data
Mar. 22, 2024 (KR) 10-2024-0039595

(51) Int. Cl. H01M 50/171

(52) U.S. Cl. CPC H01M 50/171

(57) ABSTRACT

A secondary battery includes: an electrode assembly; a case body accommodating the electrode assembly, the case body comprising an open inlet; a cover member configured to shield the inlet of the case body; and an adhesive part between the case body and the cover member, the adhesive part comprising an adhesive component to secure the cover member to an outer side of the case body, wherein the case body and the cover member are made of different materials.

### CROSS-REFERENCE TO THE RELATED APPLICATION

The present application claims priority to and the benefit of Korean Patent Application No. 10-2024-0039595, filed on Mar. 22, 2024, in the Korean Intellectual Property Office, the entire disclosure of which is incorporated herein by reference.

### BACKGROUND

### 1. Field

Aspects of some embodiments of the present disclosure relate to a secondary battery.

### 2. Description of the Related Art

Unlike a primary battery that cannot be recharged, a secondary battery is a battery that can be recharged and discharged. A low-capacity secondary battery may be used for portable small-sized electronic devices, such as smartphones, feature phones, notebook computers, digital cameras, and camcorders, and a high-capacity secondary battery may be used as a power source for driving a motor and a power storage battery in hybrid vehicles or electric vehicles. The secondary battery may include an electrode assembly having a positive electrode and a negative electrode, a case accommodating the electrode assembly, an electrode terminal connected to the electrode assembly, and the like.

The above-described information disclosed in the technology that serves as the background of the present disclosure is only for improving understanding of the background of the present disclosure and thus may include information that does not constitute the related art.

1 SUMMARY

Aspects of some embodiments of the present disclosure include a secondary battery capable of securing a cover part to an upper side of a case without a welding process.

Aspects of some embodiments of the present disclosure include a secondary battery in which the case and the cover part are made of different materials.

Aspects of some embodiments of the present disclosure include a secondary battery in which the shape of the cover part may be modified corresponding to the shapes of an electrode assembly and the case.

These and other aspects and features of the present disclosure will be described in or will be apparent from the following description of embodiments of the present disclosure.

According to some embodiments of the present disclosure, a secondary battery includes an electrode assembly, a case body accommodating the electrode assembly and including an open inlet, a cover member shielding the inlet of the case body, and an adhesive part located between the case body and the cover member and including an adhesive component to secure the cover member to an outer side of the case body.

According to some embodiments, the case body and the cover member may be made of different materials.

According to some embodiments, the cover member may be implemented as a flexible film.

According to some embodiments, the case body may include at least one of stainless steel, aluminum, or plastic.

According to some embodiments, the electrode assembly may protrude upward above the case body.

According to some embodiments, the cover member may include a cover body located above the electrode assembly, a first extension member extending downward from an edge of the cover body to be located outside the electrode assembly and located on the case body, and a second extension member bent and extending from the first extension member to the outside of an end portion of the case body and secured to the adhesive part adhered to an outer surface of the case body.

According to some embodiments, the case body may include a base member located below the electrode assembly and a sidewall member extending upward from the base member.

According to some embodiments, the adhesive part may be mounted on at least one of the upper end of the sidewall member facing the cover member or an outer surface of the sidewall member facing the cover member.

According to some embodiments, the adhesive part may include a first adhesive member mounted between the upper end of the sidewall member and the cover member and a second adhesive member mounted between an outer surface of the sidewall member and the cover member.

According to some embodiments, the cover member may include a cover body located above the electrode assembly and a fixed wing extending downward from an edge of the cover body to be fixed to the second adhesive member.

According to some embodiments, the adhesive part may be primarily adhered to the cover member and may be secondarily adhered to the sidewall member.

According to some embodiments, the adhesive part may be primarily adhered to the sidewall member and may be secondarily adhered to the cover member.

According to some embodiments, the adhesive part may be primarily adhered to each of the sidewall member and the cover member, and the adhesive part adhered to the sidewall member and the adhesive part adhered to the cover member may be secondarily adhered to each other.

According to some embodiments, the adhesive part may include a second adhesive member mounted between an outer surface of the sidewall member and the cover member.

According to some embodiments of the present disclosure, a secondary battery includes an electrode assembly, a case body accommodating the electrode assembly and including an open upper side, a cover member formed in a film shape and configured to shield the upper side of the case body, and an adhesive part located between the case body and the cover member and including an adhesive component to secure the cover member to an outer side of the case body, wherein the adhesive part is mounted on each of the case body and the cover member.

According to some embodiments, the adhesive part may include at least one of a polymer adhesive or a metal adhesive.

According to some embodiments, the adhesive part may be formed to melt at a temperature of 100° C. to 350° C. to achieve adhesion.

### BRIEF DESCRIPTION OF THE DRAWINGS

The following drawings attached to the present specification illustrate embodiments of the present disclosure, and further describe aspects and features of the present disclosure together with the detailed description of the present disclosure. Thus, the present disclosure should not be construed as being limited to the drawings:

FIGS. 1 and 2 are, respectively, a perspective view and a cross-sectional view showing aspects of a secondary battery according to some embodiments of the present disclosure;

FIG. 3 is a cross-sectional view showing a state in which a cover adhesive part according to some embodiments of the present disclosure is adhered to a cover member;

FIG. 4 is a cross-sectional view showing a state in which a body adhesive part according to some embodiments of the present disclosure is adhered to a case body;

FIG. 5 is a cross-sectional view showing a cover adhesive part and a body adhesive part according to some embodiments of the present disclosure;

FIG. 6 is a cross-sectional view showing a cover metal adhesive and a body metal adhesive according to some embodiments of the present disclosure;

FIG. 7 is a cross-sectional view showing a first composite adhesive and a second composite adhesive according to some embodiments of the present disclosure;

FIG. 8 is a cross-sectional view showing a state in which a cover member is mounted on a support wing according to some embodiments of the present disclosure;

FIG. 9 is a cross-sectional view showing a state in which a cover member is mounted in a shape surrounding an outer side of a support wing according to some embodiments of the present disclosure;

FIG. 10 is a cross-sectional view showing a state in which a cover member is mounted in a shape surrounding an upper side of an electrode assembly according to some embodiments of the present disclosure in a state in which the electrode assembly protrudes upward above a case body;

FIGS. 11a and 11b are perspective views showing a battery pack including the secondary battery according to some embodiments of the present disclosure; and

FIGS. 12a and 12b are, respectively, a perspective view and a side view showing a vehicle body and a vehicle including the battery pack according to some embodiments of the present disclosure.

### DETAILED DESCRIPTION

Hereinafter, embodiments of the present disclosure will be described, in detail, with reference to the accompanying drawings. The terms or words used in the present specification and claims are not to be limitedly interpreted as general or dictionary meanings and should be interpreted as meanings and concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the technical spirit, aspects, and features of the present disclosure. Accordingly, it should be understood that there may be various equivalents and modifications that can replace or modify the embodiments described herein at the time of filing this application.

In addition, the terms “comprise” or “include” and/or “comprising” or “including,” when used in this specification, specify the presence of stated shapes, numbers, steps, operations, members, elements, and/or groups thereof, but do not 1 preclude the presence or addition of one or more other shapes, numbers, steps, operations, members, elements, and/or groups thereof.

Additionally, for the purpose of facilitating an understanding of the invention, the attached drawings are not depicted to actual scale; dimensions of some components may be exaggerated for clarity. Also, identical components in different embodiments may be denoted with the same reference numerals.

When two objects of comparison are referred to as being the same, it means the two objects are “substantially the same.” Thus, substantially the same may include a deviation that is considered low in the art, for example, a deviation of less than 5%. In addition, when a parameter is said to be uniform in a certain region, it may mean that the parameter is uniform from an average perspective.

Although “first,” “second,” and the like are used to describe various components, these components are of course not limited by these terms. These terms are only used to distinguish one component from other components, and unless otherwise stated, a first component could be termed a second component.

Throughout the specification, unless specifically stated otherwise, each component may be singular or plural.

When an arbitrary element is referred to as being “disposed above (or below)” or “disposed on (or under)” a component, it may mean not only that the arbitrary element is disposed in contact with an upper surface (or lower surface) of the component, but also that other elements may be interposed between the component and the arbitrary element disposed on (or under) the component.

When a component is described as being “connected,” “coupled,” or “joined” to another component within this patent document, it is understood that the components may be directly connected or joined to each other. However, it should also be interpreted that an intervening component may be interposed between them, or that each component may be “connected,” “coupled,” or “joined” through another intermediary component. Furthermore, when one part is described as being electrically connected (electrically coupled) to another, this encompasses not only a direct connection but also includes scenarios where other elements are positioned in between, facilitating an indirect connection.

Throughout this specification, the term ‘A and/or B’ should be interpreted as meaning either A, B, or both A and B, unless an alternative interpretation is explicitly stated. Thus, ‘and/or’ encompasses any and all possible combinations of the items listed. Similarly, when ‘C to D’ is mentioned, it is understood to mean C or more, up to and including D, unless noted otherwise. The terminology employed herein is intended solely for describing specific embodiments and should not be regarded as limiting the scope of this disclosure.

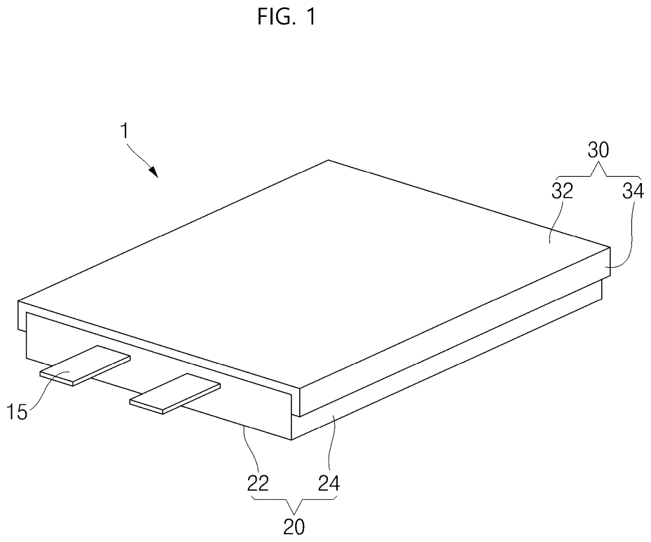

FIGS. 1 and 2 are, respectively, a perspective view and a cross-sectional view showing aspects of a secondary battery 1 according to some embodiments of the present disclosure. As shown in FIGS. 1 and 2, the secondary battery 1 according to some embodiments of the present disclosure may include an electrode assembly 10, one or more lead tabs 15, a case body 20, a cover member 30, and an adhesive part 40. In the present disclosure, the secondary battery 1 may be referred to as a battery.

The electrode assembly 10 may be accommodated in the case body 20 together with an electrolyte. The electrode assembly 10 may include or be referred to as an electrode group, an electrode body, or a jellyroll. The electrode assembly 10 may include a first electrode plate, a second electrode plate, and a separator interposed between the first electrode plate and the second electrode plate or arrangement. The components of the electrode assembly 10 may be stacked in a plate shape (e.g., a plurality of layers or plates/separators stacked in planes on top of each other). The electrode assembly 10 may be formed in various configurations, for example, a stacked configuration or a cylindrically wound configuration. The electrode assembly 10 may be configured such that the first electrode plate, the separator, and the second electrode plate are stacked in that order. According to some embodiments, the electrode assembly 10 may be configured such that the first electrode plate, the second electrode plate, and the separator, each of which has a plate shape including a small-width portion and a large-width portion consecutively connected to each other, are stacked.

The first electrode plate may include a first substrate and a first active material layer located on the first substrate. The first substrate may include a first uncoated portion or a first tab on which the first active material layer is not located. The first uncoated portion or the first tab of the first substrate may extend outward, and the first tab may be electrically connected to the lead tab 15. In the present disclosure, the first tab may be referred to as a first uncoated portion or a positive electrode substrate tab.

The second electrode plate may include a second substrate and a second active material layer located on the second substrate. The second substrate may include a second uncoated portion or a second tab on which the second active material layer is not located. The second uncoated portion or the second tab of the second substrate may extend outward, and the second tab may be electrically connected to the lead tab 15. According to some embodiments, the first tab and the second tab may be implemented in various forms, for example, may extend in the same direction or may extend in different directions. In the present disclosure, the second tab may be referred to as a second uncoated portion or a negative electrode substrate tab.

The first electrode plate may function as a positive electrode. In this case, the first substrate may be formed as, for example, an aluminum foil, and the first active material layer may include, for example, a transition metal oxide. The second electrode plate may function as a negative electrode. In this case, the second substrate may be formed as, for example, a copper foil or a nickel foil, and the second active material layer may include, for example, graphite and/or silicon.

The separator may prevent or reduce instances of a short circuit between the first electrode plate and the second electrode plate while allowing lithium ions to move therebetween. According to some embodiments, the separator may be located on each of two opposite side surfaces of the first electrode plate or may be located on each of two opposite side surfaces of the second electrode plate.

The lead tab 15 electrically connected to the electrode assembly 10 may extend to the outside of the case body 20. The lead tab 15 may be provided in a pair. One of the pair of lead tabs 15 may be electrically connected to the first electrode plate, and the other of the pair of lead tabs 15 may be electrically connected to the second electrode plate.

The case body 20 and the cover member 30 may accommodate the electrode assembly 10 and an electrolyte and may define the external appearance of the secondary battery 1. The case body 20 may include or be referred to as a can, a housing, or an exterior body. The case body 20 may include at least one of metal, such as stainless steel, nickel-plated steel, a steel alloy, aluminum, an aluminum alloy, or deep-drawing cold-rolled steel (SPCE), or a laminated film or plastic composing a pouch. According to some embodiments, the case body 20 may include at least one of aluminum, steel, stainless steel, injection-molded plastic, a polymer composite material, or glass fiber reinforced plastic.

The case body 20 may be provided with a beading portion that is depressed inwardly. The beading portion may protrude toward the interior of the case body 20 to suppress movement of the electrode assembly 10. The case body 20 may accommodate the electrode assembly 10 and may include an open inlet. The case body 20 may be variously modified in shape, so long as the case body 20 forms a case accommodating the electrode assembly 10 and having an open upper side. The case body 20 according to some embodiments of the present disclosure may include a base member 22 located below the electrode assembly 10 and a sidewall member 24 extending upward from the base member 22. The base member 22 may be formed in a plate shape and may be located below the electrode assembly 10. The sidewall member 24 may have a plate shape extending upward from the edge of the base member 22. The case body 20 may be a rigid case, and the cover member 30 may be a flexible film.

The cover member 30 may shield the inlet of the case body 20. The cover member 30 may be variously modified in shape, so long as the cover member 30 is formed as a film and shields the upper side of the case body 20. The case body 20 and the cover member 30 may be made of different materials. The cover member 30 according to some embodiments of the present disclosure may be formed as a flexible film. A laminated film composing a pouch may be used as the cover member 30. The cover member 30 according to some embodiments of the present disclosure may include a cover body 32 located above the electrode assembly 10 and a fixed wing 34 extending downward from the edge of the cover body 32 to be fixed to a second adhesive member 44. The cover member 30 may be mounted at a position facing the base member 22 and may shield the open inlet of the case body 20. The edge portion of the cover member 30 may be bent and extend downward to be fixed to the outer surface of the case body 20.

The adhesive part 40 may be variously modified in shape, so long as the adhesive part 40 is located between the case body 20 and the cover member 30, includes an adhesive component, and secures the cover member 30 to the outer side of the case body 20. The adhesive part 40 may be mounted on at least one of the upper end of the sidewall member 24 facing the cover member 30 or the outer surface of the sidewall member 24 facing the cover member 30. According to some embodiments, the adhesive part 40 may include at least one of a polymer adhesive or a metal adhesive.

A polymer adhesive may include polyurethane, polyethylene, and epoxy. The polymer adhesive may provide flexibility and strength. Because polyurethane provides a relatively high tensile strength and durability, it may be effective in securing the cover member 30 to the outer side of the case body 20.

A metal adhesive may include a metal-coated adhesive and a polymer containing metal particles. The metal adhesive may provide relatively improved adhesion as it partially melts within a set temperature range and then coagulates with decrease in temperature.

According to some embodiments, the adhesive part 40 may melt at a temperature of 100° C. to 350° C. to achieve adhesion. According to some embodiments, the adhesive part 40 may melt at a temperature of 100° C. to 350° C. and a pressure of 100 kgf/cm² to 250 kgf/cm² and may be adhered to the case body 20 and the cover member 30. The adhesive part 40 may be welded using at least one of laser welding or ultrasonic welding.

The adhesive part 40 according to some embodiments of the present disclosure may include a first adhesive member 42 mounted between the upper end of the sidewall member 24 and the cover member 30 and a second adhesive member 44 mounted between the outer surface of the sidewall member 24 and the cover member 30. According to some embodiments, the adhesive part 40 may include only the first adhesive member 42 mounted between the upper end of the sidewall member 24 and the cover member 30. According to some embodiments, the adhesive part 40 may include only the second adhesive member 44 mounted between the outer surface of the sidewall member 24 and the cover member 30.

The first adhesive member 42 may be fixed in contact with the upper end of the case body 20 and the lower surface of the cover member 30. The second adhesive member 44 may be fixed in contact with the outer surface of the case body 20 and the inner surface of the fixed wing 34 of the cover member 30.

In some systems, if a battery is used as a removable battery for smartphones, the battery needs an exterior body made of a hard material unlike a pouch-type battery, and thus a welding process is essentially performed. Further, in order to perform welding on a battery case, a separate wing space for welding is necessary, and thus an unavailable area is present in the battery.

According to some embodiments, because the cover member 30 is implemented as a pouch exterior material, the weight of the secondary battery 1 may be reduced. Because the case body 20 and the cover member 30 are fixed to each other through a compression method, a welding process may be eliminated, and thus a production speed may be relatively improved. Because the cover member 30 is formed in a film shape, the shape of the cover member 30 may be modified corresponding to the shapes of the case body 20 and the electrode assembly 10. Thus, the cover member 30 may be used in common for various models of secondary batteries, leading to reduction in transportation and production costs. Further, because there is no need to provide a separate wing space in the case body 20 in order to secure an area for a welding process, an unavailable area in the battery may be minimized or reduced, and thus the capacity of the secondary battery 1 may be relatively increased.

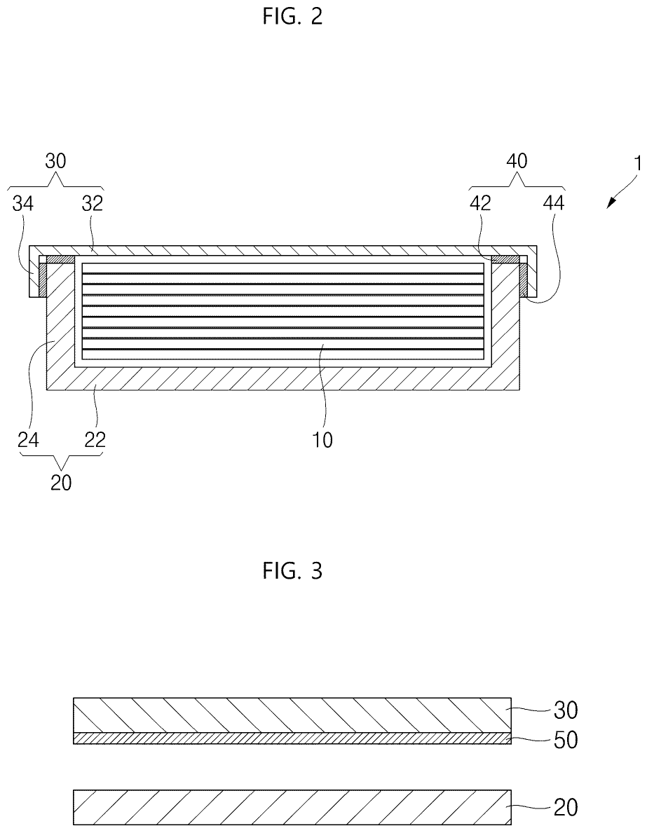

FIG. 3 is a cross-sectional view showing a state in which a cover adhesive part 50 according to some embodiments of the present disclosure is adhered to the cover member 30. As shown in FIG. 3, an adhesive part 40 may be primarily adhered to the cover member 30, and may then be secondarily adhered to the sidewall member 24. According to some embodiments, the cover adhesive part 50 including a polymer may be mounted on the pouch-type cover member 30. In a state of being primarily adhered to the cover member 30, the cover adhesive part 50 may be in contact with and thermally bonded to the case body 20 and the cover member 30, whereby the cover adhesive part 50 may be secured to the outer side of the case body 20, and thus the cover member 30 may be secured to the outer side of the case body 20.

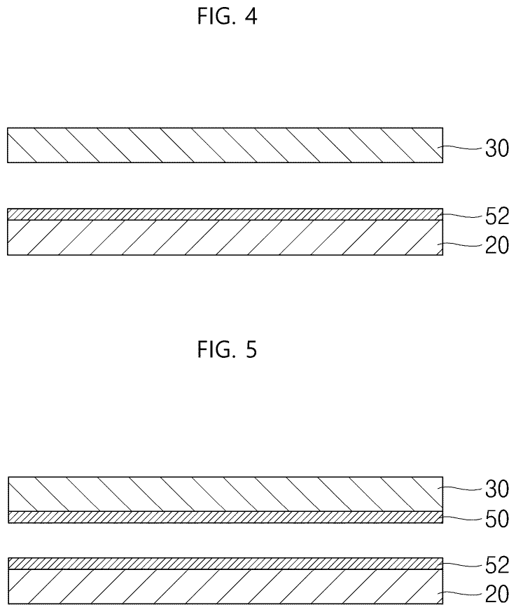

FIG. 4 is a cross-sectional view showing a state in which a body adhesive part 52 according to some embodiments of the present disclosure is adhered to the case body 20. As shown in FIG. 4, an adhesive part 40 may be primarily adhered to the sidewall member 24, and may then be secondarily adhered to the cover member 30. According to some embodiments, the body adhesive part 52 including a polymer may be mounted on the outer surface of the case body 20. In a state of being primarily adhered to the outer surface of the case body 20, the body adhesive part 52 may be in contact with and thermally bonded to the case body 20 and the cover member 30, whereby the body adhesive part 52 may be secured to the inner side of the cover member 30, and thus the cover member 30 may be secured to the outer side of the case body 20.

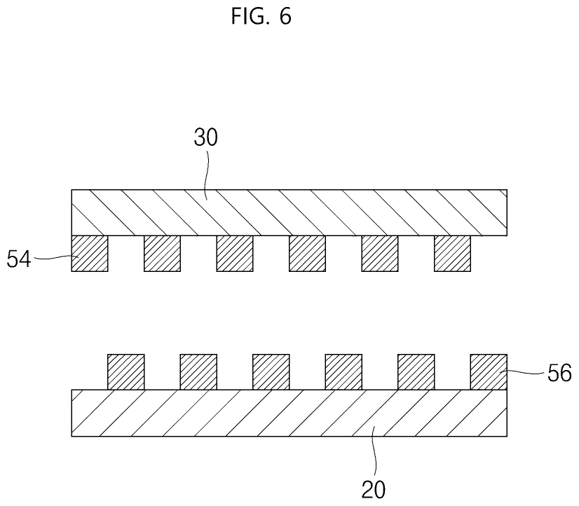

FIG. 5 is a cross-sectional view showing a cover adhesive part 50 and a body adhesive part 52 according to some embodiments of the present disclosure.

As shown in FIG. 5, an adhesive part 40 may be located between the case body 20 and the cover member 30 and may include an adhesive component. The adhesive part 40 may be variously modified, so long as the adhesive part 40 secures the cover member 30 to the outer side of the case body 20. According to some embodiments, adhesive parts 40 may be mounted on the case body 20 and the cover member 30, respectively. The adhesive parts 40 may be primarily adhered to the sidewall member 24 and the cover member 30, and then the opposing adhesive parts 40 may be secondarily adhered to each other.

The cover adhesive part 50 including a polymer may be mounted on the pouch-type cover member 30, and the body adhesive part 52 including a polymer may be mounted on the outer surface of the case body 20. The cover adhesive part 50 may be primarily adhered to the inner side of the cover member 30, and the body adhesive part 52 may be primarily adhered to the outer surface of the case body 20. The case body 20 and the cover member 30 may be in contact with and thermally bonded to each other, and thus the cover adhesive part 50 and the body adhesive part 52 may be in contact with and adhered to each other. In this way, the cover member 30 may be secured to the outer side of the case body 20.

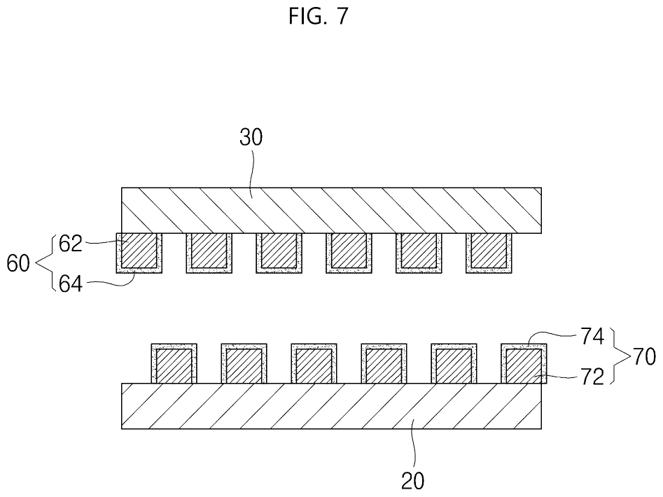

FIG. 6 is a cross-sectional view showing a cover metal adhesive 54 and a body metal adhesive 56 according to some embodiments of the present disclosure. As shown in FIG. 6, adhesive parts 40 including metal may be mounted on the case body 20 and the cover member 30, respectively.

The cover metal adhesive 54 may be primarily adhered to the inner side of the cover member 30, and the body metal adhesive 56 may be primarily adhered to the outer surface of the case body 20. The case body 20 and the cover member 30 may be in contact with and thermally bonded to each other, and thus the cover metal adhesive 54 and the body metal adhesive 56 may be in contact with and adhered to each other. In this way, the cover member 30 may be secured to the outer side of the case body 20.

The cover metal adhesive 54 may be provided in plural, and the plurality of cover metal adhesives 54 may be spaced apart from each other at set intervals and may be primarily adhered to the inner side of the cover member 30. The body metal adhesive 56 may be provided in plural, and the plurality of body metal adhesives 56 may be spaced apart from each other at set intervals and may be primarily adhered to the outer surface of the case body 20. The cover metal adhesives 54 and the body metal adhesives 56 may be mounted in a zigzag pattern so as to be misaligned from each other. Thus, if the cover member 30 is secured to the outer side of the case body 20, the cover metal adhesives 54 may come into direct contact with and be adhered to the case body 20 without contacting the body metal adhesives 56. Further, the body metal adhesives 56 may come into direct contact with and be adhered to the cover member 30 without contacting the cover metal adhesives 54. Because the cover metal adhesives 54 and the body metal adhesives 56 are mounted so as to be misaligned from each other, the thickness of the adhesive part 40 may be reduced, and thus the secondary battery 1 may be designed to have a compact configuration.

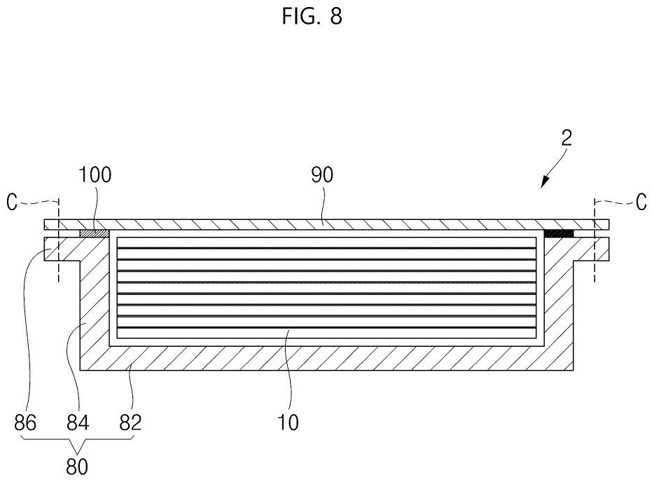

FIG. 7 is a cross-sectional view showing a first composite adhesive 60 and a second composite adhesive 70 according to some embodiments of the present disclosure. As shown in FIG. 7, adhesive parts 40, each including metal and a polymer, may be mounted on the case body 20 and the cover member 30, respectively.

The first composite adhesive 60 may be mounted such that a first inner adhesive 62 including a metal component is first adhered to the cover member 30 and then a first outer adhesive 64 wraps the outer side of the first inner adhesive 62. The first outer adhesive 64 may include a polymer.

The second composite adhesive 70 may be mounted such that a second inner adhesive 72 including a metal component is first adhered to the case body 20 and then a second outer adhesive 74 wraps the outer side of the second inner adhesive 72. The second outer adhesive 74 may include a polymer.

The first composite adhesive 60 may be primarily adhered to the inner side of the cover member 30, and the second composite adhesive 70 may be primarily adhered to the outer surface of the case body 20. The case body 20 and the cover member 30 may be in contact with and thermally bonded to each other, and thus the first composite adhesive 60 and the second composite adhesive 70 may be in contact with and adhered to each other. In this way, the cover member 30 may be secured to the outer side of the case body 20.

The first composite adhesive 60 may be provided in plural, and the plurality of first composite adhesives 60 may be spaced apart from each other at set intervals and may be primarily adhered to the inner side of the cover member 30. The second composite adhesive 70 may be provided in plural, and the plurality of second composite adhesives 70 may be spaced apart from each other at set intervals and may be primarily adhered to the outer surface of the case body 20. The first composite adhesives 60 and the second composite adhesives 70 may be mounted in a zigzag pattern so as to be misaligned from each other. Thus, if the cover member 30 is secured to the outer side of the case body 20, the first composite adhesives 60 may come into direct contact with and be adhered to the case body 20 without contacting the second composite adhesives 70. The first inner adhesives 62 and the second inner adhesives 72 may be mounted so as to be misaligned from each other, and the first outer adhesives 64 and the second outer adhesives 74 may be mounted so as to partially overlap each other. Because the first outer adhesives 64 including a polymer and the second outer adhesives 74 including a polymer are mounted so as to partially overlap each other, coupling force between the first composite adhesives 60 and the second composite adhesives 70 may be further increased during thermal bonding. The second composite adhesives 70 may come into direct contact with and be adhered to the cover member 30 without contacting the first composite adhesives 60. Because the first composite adhesives 60 and the second composite adhesives 70 are mounted so as to be misaligned from each other, the thickness of the adhesive part 40 may be reduced, and thus the secondary battery 1 may be designed to have a compact configuration.

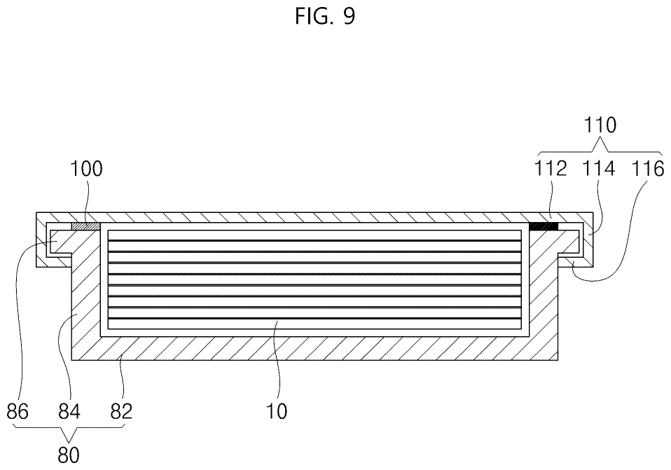

FIG. 8 is a cross-sectional view showing a state in which a cover member 90 is mounted on a support wing 86 according to some embodiments of the present disclosure. As shown in FIG. 8, a secondary battery 2 according to some embodiments of the present disclosure may include a case body 80, an electrode assembly 10, and a cover member 90. The case body 80 may include a base member 82 located below the electrode assembly 10, a sidewall member 84 extending upward from the base member 82, and a support wing 86 bent and extending outward from the upper end of the sidewall member 84 so as to face the cover member 90. The support wing 86 may be mounted in a shape extending horizontally from the upper end of the sidewall member 84.

The cover member 90 may be implemented as a flexible film. An adhesive part 100 may be mounted on at least one of the upper end of the sidewall member 84 or the support wing 86 and may secure the cover member 90 to the upper side of the case body 80. The adhesive part 100 may be located on the upper end of the sidewall member 84 and may secure the cover member 90 to the upper end of the sidewall member 84.

In a state in which the cover member 90 is secured to the upper side of the case body 80, a portion of the cover member 90 and a portion of the support wing 86 may be cut along a cutting line C extending vertically. Because the support wing 86 and the cover member 90 facing the support wing 86 do not affect the capacity of the secondary battery 2, the position of the cutting line C may be set to a position outside the adhesive part 100.

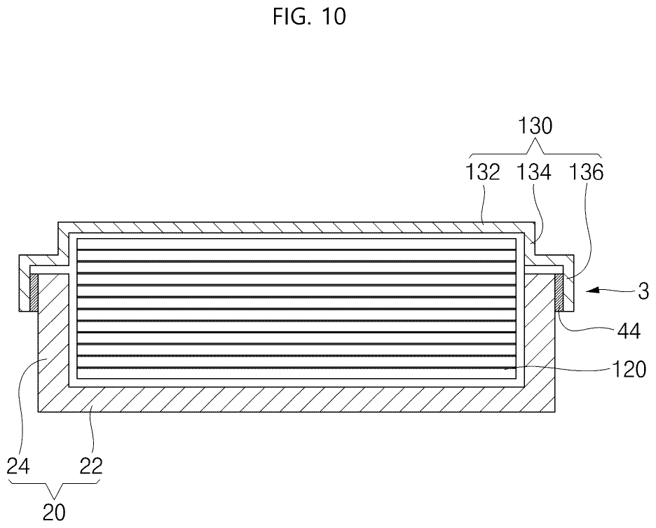

FIG. 9 is a cross-sectional view showing a state in which a cover member 110 is mounted in a shape surrounding an outer side of a support wing 86 according to some embodiments of the present disclosure. As shown in FIG. 9, a cover member 110 may be mounted on the case body 80 including the support wing 86. The cover member 110 may be mounted in a shape surrounding the outer side of the support wing 86 and may be secured by the adhesive part 100. According to some embodiments, the cover member 110 may include a cover body 112 located above the base member 82 to cover the upper side of the electrode assembly 10, a fixed wing 114 extending downward from the edge of the cover body 112, and a bent protrusion 116 extending from the lower end of the fixed wing 114 toward the sidewall member 84. The fixed wing 114 may be located outside the sidewall member 84 and may extend vertically, and the bent protrusion 116 may be located below the support wing 86.

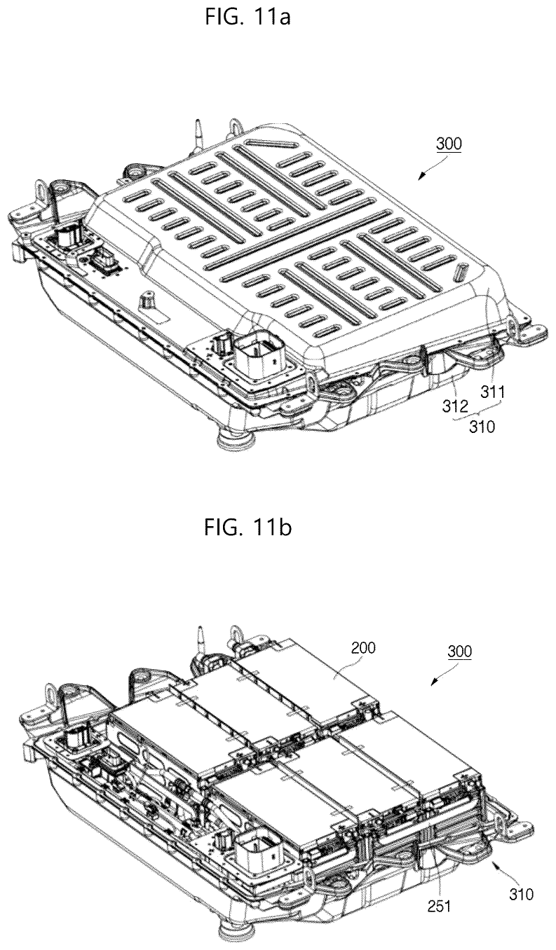

FIG. 10 is a cross-sectional view showing a state in which a cover member 130 is mounted in a shape surrounding an upper side of an electrode assembly 120 according to some embodiments of the present disclosure in a state in which the electrode assembly 120 protrudes upward above a case body 20. As shown in FIG. 10, according to some embodiments, a secondary battery 3 may include a case body 20, an electrode assembly 120, and a cover member 130.

The electrode assembly 120 may protrude upward above the case body 20. The electrode assembly 120 may be formed to be higher than a sidewall member 24 of the case body 20. The cover member 130 may be mounted in a shape surrounding the upper side of the electrode assembly 120 protruding upward above the case body 20 and may be secured to the outer side of the case body 20 by an adhesive part 40. According to some embodiments, the cover member 130 may include a cover body 132 located above the electrode assembly 120, a first extension member 134 extending downward from the edge of the cover body 132 to be located outside the electrode assembly 120 and located on the case body 20, and a second extension member 136 bent and extending from the first extension member 134 to the outside of the end portion of the case body 20 and secured to the adhesive part 40 adhered to the outer surface of the case body 20. The adhesive part 40 adhered to the outer surface of the case body 20 may be referred to as a second adhesive member 44 adhered to the outer surface of the sidewall member 24.

The cover member 130 may be implemented as a flexible film, and the shape of the cover member 130 may be modified corresponding to the shapes of the case body 20 and the electrode assembly 120. The shape of the cover member 130 may be modified by the shape of a mold that moves from a region above the cover member 130 toward a region below the cover member 130.

The first extension member 134, which extends downward from the edge of the cover body 132 mounted in contact with the upper side of the electrode assembly 120, may be mounted in a shape facing the side surface of the electrode assembly 120. The second extension member 136, which is bent and extends from the lower end of the first extension member 134 to the outside of the case body 20, may be secured to the outer side of the case body 20 by the adhesive part 40.

Because the shape of the flexible cover member 130 is freely modified corresponding to the shapes of the electrode assembly 120 and the case body 20, there is no need to produce cover members of different shapes for various models of secondary batteries, and thus production cost may be reduced.

Hereinafter, the electrode assemblies 10 and 120 will be described in more detail.

As the positive electrode active material, a compound capable of reversibly intercalating/deintercalating lithium (e.g., a lithiated intercalation compound) may be used. For example, at least one of a composite oxide of lithium or a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O₂₋ₐDₐ (0.90≤a≤1.8, 0≤b ≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a current collector and a positive electrode active material layer formed on the current collector. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The current collector may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be 1 silicon, a silicon-carbon composite, SiOx (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a current collector and a negative electrode active material layer disposed on the current collector. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode current collector, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film of two or more layers thereof may be used.

The separator may include a porous substrate and a coating layer including an organic material, an inorganic material, or a combination thereof on one or both surfaces of the porous substrate.

The organic material may include a polyvinylidene fluoride-based heavy antibody or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer containing an organic material and a coating layer containing an inorganic material that are laminated on each other.

The battery according to the above-described embodiments may be used to manufacture a battery pack.

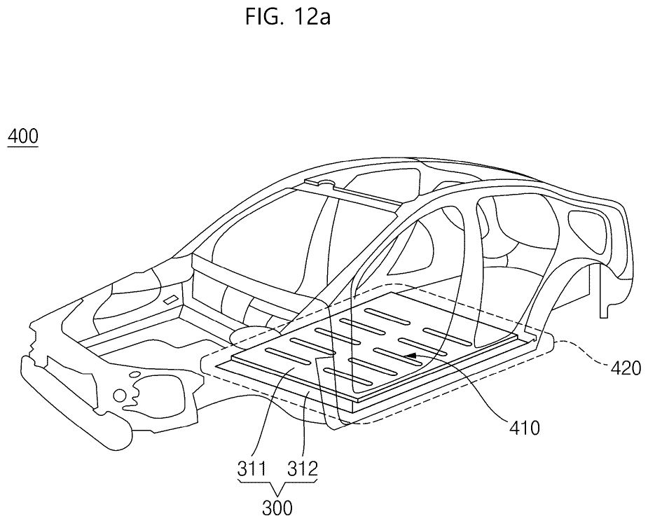

FIGS. 11a and 11b are perspective views showing a battery pack including a secondary battery according to some embodiments of the present disclosure.

Referring to FIGS. 11a and 11b, the battery pack 300 may include a plurality of battery modules 200 and a housing 310 to accommodate the plurality of battery modules 200. For example, the housing 310 may comprise a first and a second housing 311, 312 that are coupled in facing directions with the plurality of battery modules 200 interposed between them. The plurality of battery modules 210 can be electrically connected to each other using a bus bar 251, and the plurality of battery modules 200 can be electrically connected in series/parallel or a mixed series-parallel manner to obtain the required electrical output. In the drawings, for the sake of convenience, components such as bus bars, cooling units, and external terminals for the electrical connection of battery cells are omitted. In some embodiments, the battery pack 300 can be mounted on a vehicle. The vehicle may be, for example, an electric vehicle, a hybrid vehicle, or a plug-in hybrid vehicle. The vehicle can include both four-wheel and two-wheel vehicles.

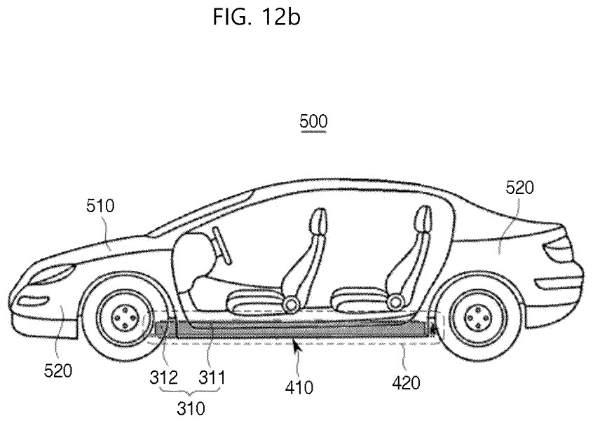

FIGS. 12a and 12b are, respectively, a perspective view and a side view showing a vehicle body 400 and a vehicle 500 including the battery pack 300 according to some embodiments of the present disclosure.

In FIG. 12a, the battery pack 300 may include a battery pack cover 311, which is part of the vehicle underbody 410 and may correspond to the first housing, and a pack frame 312, which is placed beneath the vehicle underbody 410 and may correspond to the second housing. The battery pack cover 311 and pack frame 312 may be structurally integrated with the vehicle floor 420. The vehicle underbody 410 separates the interior and exterior of the vehicle, and the pack frame 312 may be positioned outside the vehicle.

As shown in FIG. 12b, the vehicle 500 can be assembled with additional components such as a hood 510 at the front of the vehicle body 400 and fenders 520 located at the front and rear of the vehicle. The vehicle 500 includes the battery pack 300 comprising the battery pack cover 311 and the pack frame 312, and the battery pack 300 can be coupled to the vehicle body part 400.

As is apparent from the above description, according to some embodiments of the present disclosure, a cover member may be secured to an upper side of a case body without a welding process, whereby an error rate may be reduced, and productivity may be relatively improved.

According to some embodiments of the present disclosure, because the case body and the cover member are made of different materials and the cover member is implemented as a flexible film, the cover member may be used in common for various models of secondary batteries, leading to reduction in production cost.

According to some embodiments of the present disclosure, because the cover member is implemented as a flexible film, the weight of a secondary battery may be relatively reduced.

However, the effects achievable through the present invention are not limited to those described above, and other technical effects not mentioned can be clearly understood by those skilled in the art from the description of the invention provided above.

What is claimed is:

1. A secondary battery comprising:
an electrode assembly;
a case body accommodating the electrode assembly, the case body comprising an open inlet;
a cover member configured to shield the open inlet of the case body; and
an adhesive part between the case body and the cover member, the adhesive part comprising an adhesive component to secure the cover member to an outer side of the case body,
wherein the case body and the cover member are made of different materials.

2. The secondary battery as claimed in claim 1, wherein the cover member is a flexible film.

3. The secondary battery as claimed in claim 1, wherein the case body comprises at least one of stainless steel, aluminum, or plastic.

4. The secondary battery as claimed in claim 3, wherein the electrode assembly protrudes upward above the case body.

5. The secondary battery as claimed in claim 4, wherein the cover member comprises:
a cover body above the electrode assembly;
a first extension member extending downward from an edge of the cover body to be located outside the electrode assembly and located on the case body; and
a second extension member bent and extending from the first extension member to an outside of an end portion of the case body and secured to the adhesive part adhered to an outer surface of the case body.

6. The secondary battery as claimed in claim 1, wherein the case body comprises:
a base member below the electrode assembly; and
a sidewall member extending upward from the base member, and
wherein the adhesive part is mounted on at least one of an upper end of the sidewall member facing the cover member or an outer surface of the sidewall member facing the cover member.

7. The secondary battery as claimed in claim 6, wherein the adhesive part comprises:
a first adhesive member mounted between an upper end of the sidewall member and the cover member; and
a second adhesive member mounted between an outer surface of the sidewall member and the cover member.

8. The secondary battery as claimed in claim 7, wherein the cover member comprises:
a cover body above the electrode assembly; and
a fixed wing extending downward from an edge of the cover body to be fixed to the second adhesive member.

9. The secondary battery as claimed in claim 6, wherein the adhesive part is primarily adhered to the cover member and is secondarily adhered to the sidewall member.

10. The secondary battery as claimed in claim 6, wherein the adhesive part is primarily adhered to the sidewall member and is secondarily adhered to the cover member.

11. The secondary battery as claimed in claim 6, wherein the adhesive part is primarily adhered to each of the sidewall member and the cover member, and the adhesive part adhered to the sidewall member and the adhesive part adhered to the cover member are secondarily adhered to each other.

12. The secondary battery as claimed in claim 6, wherein the adhesive part comprises a second adhesive member mounted between an outer surface of the sidewall member and the cover member.

13. A secondary battery comprising:
an electrode assembly;
a case body accommodating the electrode assembly, the case body comprising an open upper side;
a cover member formed in a film shape and configured to shield the upper side of the case body; and
an adhesive part located between the case body and the cover member, the adhesive part comprising an adhesive component to secure the cover member to an outer side of the case body,
wherein the adhesive part is mounted on each of the case body and the cover member.

14. The secondary battery as claimed in claim 13, wherein the adhesive part comprises at least one of a polymer adhesive or a metal adhesive.

15. The secondary battery as claimed in claim 13, wherein the adhesive part is configured to melt at a temperature of 100° C. to 350° C. to achieve adhesion.
